(19) United States
(12) Patent Application Publication
(10) Pub. No.: US 2007/0100685 A1
(43) Pub. Date: May 3, 2007

(54) Portfolio infrastructure management method and system

(75) Inventors: David J. Brickhaus, St. Charles, MO (US); Rick Felts, Dallas, TX (US); Dan Ajibola, Menomonee Falls, WI (US); Patti Callahan, Florissant, MO (US); Linda Y. Clark, Vallejo, CA (US); Richard E. Craft, Palatine, IL (US); Gary R. Dial, Collinsville, IL (US); Fred K. Dickinson JR., Creve Coeur, MO (US); Jill D. Hohler, Oakey, CA (US); Barbara Ann Hussey, Des Peres, MO (US); Richard J. Kilian, San Ramon, CA (US); Andy Lock, St. Charles, MO (US); Herbert L. Patten, San Mateo, CA (US); Diane Pickler, Ballwin, MO (US); David Lloyd Roberts, Milwaukee, WI (US); Shari Roether-Ham, Long Beach, CA (US); Susan H. Santamauro, Milford, CT (US); Joel Schwartz, Plano, TX (US); Kim Michele Simmons, St. Louis, MO (US); Gary Smith, Belleville, IL (US); John J. Weisenbach, Indianapolis, IN (US)

Correspondence Address: TOLER SCHAFFER, LLP, 8500 BLUFFSTONE COVE, SUITE A201, AUSTIN, TX, 78759, US

(73) Assignee: SBC Knowledge Ventures, L.P., Reno, NV (US)

(21) Appl. No.: 11/263,676

(22) Filed: Oct. 31, 2005

(51) Int. Cl. G06F 17/30

(52) U.S. Cl. 705/10

(57) ABSTRACT

A forecast need of at least one data center for a future time is determined based on anticipated-resource-usage values for a plurality of anticipated projects. If an existing inventory of data center components does not satisfy the forecast need, at least one data center component is procured from at least one external supplier. A respective amount of resources of the at least one data center component is allocated to approved ones of the anticipated projects. Each of the approved ones of the anticipated projects is charged for said procuring based on the respective amount of resources allocated thereto.

### FIELD OF THE DISCLOSURE

The present disclosure is generally related to management of infrastructure to deploy information technology projects.

### BACKGROUND

Organizations often have multiple teams working on multiple Information Technology (IT) projects. Some organizations manage their multiple IT projects on a project-to-project basis wherein each IT project is individually evaluated, estimated, solutioned and deployed.

For example, each project may be evaluated to determine whether or not to approve the project. After a project is approved and funded, the project may purchase hardware having a resource capacity suitable for deploying its project application. Each project that is approved and funded is responsible for obtaining and assuming ownership of its own hardware to run its project application. As a result, many single-project, single-solution environments are produced by the organization.

The project-to-project approach has many shortcomings. The acquisition of hardware on a project-to-project basis is not conducive to volume purchases and lower per-unit costs. Further, the resources of the organization are under-utilized by the resultant single-project, single-solution environments. For example, unused resources for a hardware item purchased by one project may not be available for use by another project. Still further, since each project creates its own project-specific infrastructure solution, the organization may have disparate infrastructure solutions for its multiple projects. This limits flexibility in driving widespread technology changes in the organization. Yet still further, each project that procures equipment has equipment delivery and setup times in its project timeline.

Additionally, project-to-project purchases may cause a project to pay for a full incremental cost if the project causes an incremental spend. For example, consider an organization having an existing 32-port switch of which twelve open ports are available. If a project is proposed that requests ten ports, ten of the twelve open ports may be given to the project at no charge, leaving two open ports. If a subsequent project is proposed that requests more than the two open ports of the existing 32-port switch (e.g. the subsequent project requests four ports), the subsequent project may be charged for an entire purchase of a new 32-port switch.

### BRIEF DESCRIPTION OF THE DRAWINGS

FIG. 1 is a block diagram of an embodiment of a portfolio infrastructure management system;

FIG. 2 is a flow chart of an embodiment of a method of infrastructure acquisition planning for multiple projects;

FIG. 3 is a flow chart of an embodiment of a method of project consultation and assessment in an infrastructure provisioning process;

FIG. 4 is a flow chart of an embodiment of a method of project definition and funding in an infrastructure provisioning process;

FIG. 5 is a flow chart of an embodiment of a method of project development and testing in an infrastructure provisioning process;

FIG. 6 is a flow chart of an embodiment of a method of project deployment in the infrastructure provisioning process;

FIG. 7 is a flow chart of an embodiment of recurring activities in the infrastructure provisioning process; and

FIG. 8 is a block diagram of an illustrative embodiment of a general computer system.

### DETAILED DESCRIPTION OF THE DRAWINGS

Embodiments of portfolio infrastructure management (PIM) methods and systems are disclosed herein. The PIM methods and systems act to acquire, fund, provision and manage IT infrastructure hardware for multiple existing and anticipated projects of an organization. The PIM methods and systems can promote higher volume purchases and lower per-unit costs, less unused resources, and more flexibility in driving technology changes in the organization. Further, by acquiring and partially installing IT infrastructure equipment for anticipated projects before the projects are officially approved, the delivery and setup times are removed from their individual project timelines.

Additionally, the PIM methods and systems charge each of the projects for supporting infrastructure costs on a pro-rated, usage basis after the IT infrastructure equipment is acquired. Thus, the costs are apportioned or otherwise spread over all deploying projects based on each project's usage or capacity. This mitigates budget challenges that would otherwise result from projects that cause a need for procuring a next increment of infrastructure.

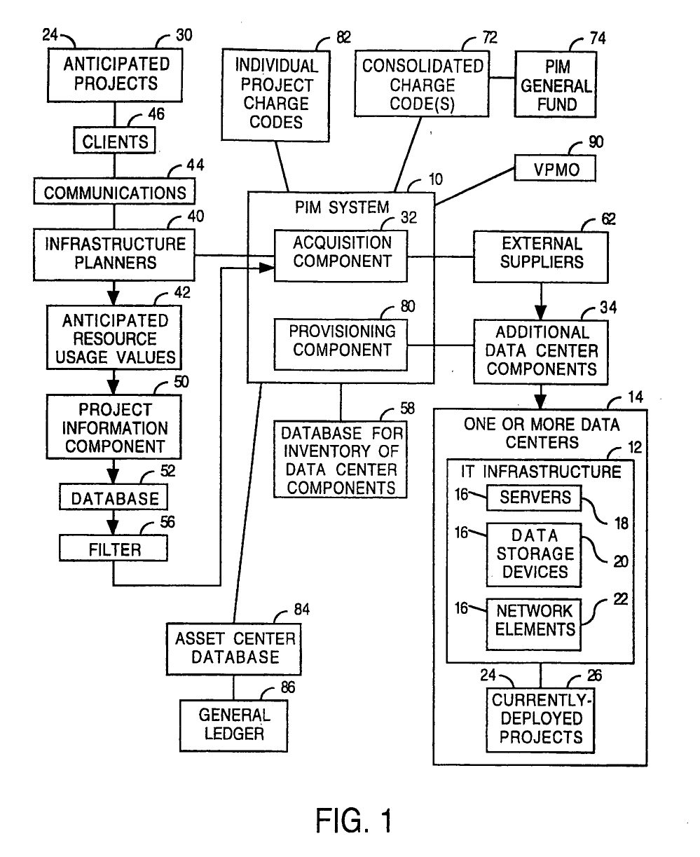

FIG. 1 is a block diagram of an embodiment of a PIM system 10. The PIM system 10 manages a portfolio of IT infrastructure 12 in one or more data centers 14 of an organization. The organization may be all or part of a business organization (e.g. a corporation or an enterprise), all or part of a government organization, or another organization that uses IT infrastructure.

The IT infrastructure 12 comprises a plurality of data center components 16 such as one or more servers 18, one or more mass data storage devices 20, and one or more network elements 22. The IT infrastructure 12 may be located in any number of data centers 14. For purposes of illustration and example, the data centers 14 may comprise about ten data centers.

The PIM system 10 manages the portfolio of IT infrastructure 12 for multiple projects 24 of the organization. The multiple projects 24 include currently-deployed projects 26 and anticipated projects 30. The currently-deployed projects 26 are those projects that are currently deployed in the data centers 14 by the IT infrastructure 12. The anticipated projects 30 are those projects that are not currently deployed in the data centers 14 by the IT infrastructure 12, but are anticipated to be deployed in the future.

Some or all of the anticipated projects 30 may not have been formally proposed and approved at this point in time. Thus, some of the anticipated projects 30 may be subsequently canceled before being formally proposed and others may be subsequently canceled after being formally proposed. Therefore, not all of the anticipated projects 30 will necessarily be approved and mature to deployment in the data centers 14.

The PIM system 10 comprises an Infrastructure Acquisition Process (IAP) component 32 that is used to manage the process of procuring and/or otherwise acquiring additional data center components 34 for the organization. The additional data center components 34 are to be acquired to meet future needs of the data centers 14 (which may comprise existing data centers end/or new data centers) to deploy the anticipated projects 30.

The IAP component 32 is used by one or more infrastructure planners 40 to determine one or more forecast needs of the data centers 14 for a given time in the future. The one or more forecast needs are based on anticipated-resource-usage values 42 for the anticipated projects 30.

The anticipated resource-usage values 42 may be determined based on communications 44 between the infrastructure planners 40 and clients 46 who desire the anticipated projects 30. The clients 46 may comprise project managers, members of application groups end/or other members of the organization.

In the communications 44, the clients 46 inform the infrastructure planners 40 of the anticipated projects 30 and make initial business cases for funding. The communications 44 may occur on either a regular or an irregular basis. The communications 44 allow the infrastructure planners 40 to get intelligence on potential future projects before the projects have been formally proposed end/or funded.

Based on the communications 44, the infrastructure planners 40 determine high-level estimates of the anticipated resources-usage values 42 and costs for the anticipated projects 30. The infrastructure planners 40 also make time estimates of when each of the anticipated projects 30 will need the infrastructure resources. The infrastructure planners 40 may determine a respective high-level estimate of anticipated-resource-usage values, costs and due dates either for each anticipated project or for one or more suites of anticipated projects.

Different measures of usage of data center components may be represented by the anticipated-resource-usage values 42. Examples of the measures of usage include, but are not limited to, an amount of data storage capacity anticipated to be needed by a project, a server transaction rate (e.g. a number of transactions per minute) anticipated to be needed by a project, an amount of processing capacity anticipated to be needed by a project, a number of ports anticipated to be needed by a project, and an amount of bandwidth anticipated to be needed by a project.

The infrastructure planners 40 also may identify other aspects of the infrastructure to enable one or more of the anticipated projects 30. Examples of the other aspects include, but are not limited to, identifying a particular data center at which to deploy an anticipated project, and identifying a particular platform (e.g. Windows, Unix, mainframe) for which to deploy the anticipated project.

The infrastructure planners 40 also evaluate the anticipated projects 30 based on the needs of the organization. Based on this evaluation, the infrastructure planners 40 assign an importance value and a confidence value to each anticipated project. The importance value indicates the project's importance to the organization. The confidence value indicates a level of confidence that the project will mature to deployment (e.g. be approved and funded). The importance value and the confidence value may be either quantitative (e.g. a value from 0-100%) or qualitative (e.g. high, medium or low).

The one or more forecast needs may also be based on one or more non-project-specific needs of the data centers 14. The non-project-specific needs are identified by the infrastructure planners 40. Examples of the non-project-specific needs include, but are not limited to, a disaster recovery need, a data center security need, and a networking need. The non-project-specific needs require resources that will be used by some, most or all of the anticipated projects 30 when deployed.

For disaster recovery, the infrastructure planners 40 may assign a disaster recovery (DR) priority value for each anticipated project. Those anticipated projects with a higher DR priority may require more non-project-specific needs than other anticipated projects having a lower DR priority.

Any of the herein-disclosed project information from the high-level evaluations is entered by the infrastructure planners 40 into a project information workbook (PIW) component 50. The PIW component 50 stores the project information in a database 52. The forecast is made based on project information retrieved from the database 52.

The one or more forecast needs may be based on a subset of the anticipated projects 30, and not based on those of the anticipated projects 30 not in the subset. The subset can be produced by a filter 56 that filters the anticipated projects 30 based on one or more filtering criteria.

The filtering criteria may be to include an anticipated project in the subset if its due date is at or before the future time for which the forecast is being made, and if its confidence value is greater than or equal to a confidence threshold end/or if its importance value is greater than or equal to an importance threshold. Using the filtering criteria, the one or more forecast needs are based on only those of the anticipated projects 30 that are not too distant-in-time and have a desirably-high level of confidence of being approved and funded end/or a desirably high level of importance to the organization.

In some embodiments, the amount of time between the future time and the present time is between 60 to 120 days, inclusive. In general, the amount of time into the future may be selected to be less than or equal to one year from a present time. By looking ahead less than a year, the forecast needs can be determined for a future time that is within a current calendar year or a current fiscal year of the organization.

In some embodiments, the confidence threshold end/or the importance threshold vary of the course of the calendar or fiscal year. For example, the confidence threshold can be lesser when making a forecast early in the year, and greater when making a forecast later in the year. This reflects a willingness to take greater risks in purchases earlier in the calendar or fiscal year. As a result, purchases of additional data center components are promoted early in the year and discouraged at or near the end of the year.

In an alternative embodiment, the amount of time into the future can vary over the course of the calendar or fiscal year. For example, the amount of time into the future can be greater when making a forecast early in the year, and lesser when making a forecast later in the year. This alternative embodiment also promotes purchases of additional data center components early in the year, and discourages purchases of additional data center components at or near the end of the year.

The IAP component 32 accesses a database 58 to determine if an inventory of data center components satisfies the forecast needs. The database 58 identifies each data center component and its status. The data center components 16 that are installed and operational in the data centers 14 are identified by a first status value (e.g. “PIM ready” or “PIM complete”). Those data center components that are currently being installed in the data centers 14 are identified by a second status value (e.g. “install”). Those data center components that have been ordered and are either en route from an external supplier or have been received but are pending commencement of installation are identified by a third status value (e.g. “pending install”). The inventory considered for satisfying the forecast needs comprises those having either the first, second or third status value in the database 58.

When the inventory does not satisfy the forecast needs, the infrastructure planners 40 and one or more subject-matter experts select the additional data center components 34 that to be acquired to meet the future needs of the data centers 14. The infrastructure planners 40 and the subject-matter experts attempt to make purchases of the additional data center components 34 to minimize or otherwise reduce costs per unit resources.

Each of the subject-matter experts has expertise in his/her own particular area of components. Each subject-matter expert may have expertise for a particular class of components (e.g. either server, storage, or network) end/or for a particular manufacturer of components.

The selection of the additional data center components 34 may include selecting a partitionable data center component that can deploy multiple ones of the anticipated projects 30. For example, consider the anticipated projects 30 comprising a first project and a second project. A first data center component may be selected because its capacity satisfies both a first anticipated-resource-usage value of the first project and a second anticipated-resource-usage value of the second project. In general, the additional data center components 34 can include any number of partitionable data center components, and each of the partitionable data center components may selected to deploy any number of the anticipated projects 30. Selecting larger partitionable data center components promotes lower per-unit resource costs and fewer unused resources.

The selection of the additional data center components 34 may be based on if a technology shift is desired for the data centers 14. When the technology shift is desired, the selection may be of one or more data center components that have the technology shift. Optionally, when the technology shift is desired, the selection may ensure that none of the additional data center components 34 is inconsistent with the technology shift. Optionally, when a technology shift is not desired, the selection may ensure that none of the additional data center components 34 has the technology shift. Instituting the technology shift concurrently for multiple anticipated projects promotes flexibility in driving widespread technology changes in the organization.

Quotes for the additional data center components,34, once selected, can be requested end/or received from one or more external suppliers 62. When the additional data center components 34 are selected to satisfy the forecast needs of many different anticipated projects, the quotes may be for bulk quantities of infrastructure (e.g. servers, storage devices, and network elements). The organization may request end/or receive volume discounts from the external suppliers 62 for a potential bulk purchase of infrastructure. The volume discounts result in lower per-unit resource costs than if infrastructure equipment was purchased on a project-to-project basis.

Based on the best offers in the quotes, the infrastructure planners 40 purchase the additional data center components 34 from one or more of the external suppliers 62 to satisfy the forecast needs. At least one consolidated charge code 72 is used to pay for the additional data center components 34 being procured. The at least one consolidated charge code 72 allows purchases to be paid for from a PIM general fund 74. In this way, funding for the procurement is managed at a portfolio level.

Based on the purchase, the additional data center components 34 are delivered to the organization. A system introduction team manages installation of the additional data center components 34 in the data centers 14. The additional data center components 34 are installed up to a point that requires individual application customization. After the installation is completed, the additional data center components 34 are made eligible for deploying applications. To indicate completion of the installation, the additional data center components 34 are identified in the database 58 as having the first status value (e.g. “PIM complete” or “PIM ready”).

The above installation may be completed before some or all of the anticipated projects 30 have been formally proposed, approved and funded. Optionally, the procurement and installation are performed using a just-in-time inventory management process. By acquiring and partially installing the additional data center components 34 for anticipated projects before they are officially approved and funded, the delivery and setup times are removed from their individual project timelines. By removing delivery and setup times from project timelines, some project deployment times may be reduced by about 10%. The resulting reduction in implementation times is especially valuable in large-volume projects.

Thus, as described above, the IAP component 32 of the PIM system 10 can be used to manage placement of bulk quantities of infrastructure within the data centers 14. The PIM system 10 further comprises an Infrastructure Provisioning Process (IPP) component 80 that is responsible for allocating the installed, bulk hardware to individual projects.

When an anticipated project is approved and officially funded, the IPP component 80 allocates a respective amount of the resources of the additional data center components 34 to the project. The amount of resources allocated to each approved project may be based on either its anticipated-resource-usage value(s) end/or its revised resource-usage value(s). For example, some or all of the anticipated-resource-usage values may be revised in light of further review, input from additional people, additional information end/or changing circumstances.

Examples of allocated amounts of resources for each project include, but are not limited to, a respective amount of storage space in at least one data storage component, a respective transaction rate of at least one server, a respective amount of processing resources of at least one server, a respective number of ports of at least one switch or another network element, a respective bandwidth of at least one network element, or any combination thereof.

The IPP component 80 charges each officially-funded project for the purchase based on its respective amount of usage allocated thereto. The IPP component 80 can further charge each officially-funded project a pro-rated portion of a cost associated with satisfying non-project-specific needs. In this way, the IPP component 80 charges each officially-funded project for its pro-rated portion of the purchase on a usage or capacity basis rather than on a hardware component basis.

The IPP component 80 may charge each of the officially-funded projects by reclassifying charges from the at least one consolidated charge code 72 to a plurality of individual project charge codes 82. By reclassifying charges, one or more of the additional data center components 34 can be procured and installed before funding is authorized for one or more of the anticipated projects 30. After a project is officially funded, a portion (e.g. its pro-rated portion) of the charge associated with the purchase can be reclassified from the at least one consolidated charge code 72 to a charge code of the project.

Ideally, at the end of a fiscal year for the organization, all or substantially all of the charges made using the at least one consolidated charge code 72 are reclassified to individual project charge codes (or are otherwise recovered from the individual projects). Thereafter, at the beginning of the next fiscal year, a large purchase can be made using the at least one consolidated charge code 72.

For purposes of illustration and example, consider the herein-described example of a first project that requests ten ports and a second project that requests four ports. In contrast to paying for incremental costs as described in the example, the PIM system 10 charges each project for its respective percentage of infrastructure being occupied. For instance, the PIM system 10 may purchase one or more 32-port switches at the corporate level. The PIM system 10 charges the first project for 10/32 of the price of a 32-port switch, and charges the second project for 4/32 of the price of a 32-port switch. The first project and the second project may be deployed on the same 32-port switch, or on different 32-port switches.

Further for purposes of illustration and example, consider a project that requires 20,000 transactions per minute (TPMs). Using a project-to-project approach, the project would pay for an entire server that most closely provides 20,000 TPMs, and the entire server would be used to deploy the project.

In contrast, using the PIM system 10, a larger server may be procured and partitioned for the project and one or more other projects. The PIM system 10 allocates 20,000 TPMs from the larger server to the project, and allocates a respective number of TPMs to each of the other project(s). The PIM system 10 charges the project a fraction of the price of the larger server, the fraction being based on the 20,000 TPMs relative to the transaction capacity of the larger server.

By deploying several projects on one server, asset utilization is improved by consolidating and reducing a resulting overhead that would otherwise be held by each project. The IPP component 80 specifically provisions and charges for those resources required by a given project. The net result of costing and provisioning on a usage/capacity basis rather than a hardware component basis is more processing on a given set of equipment, and more accurate cost estimates for the hosted projects.

The PIM system 10 drives a paradigm shift from project assets to corporate assets with regard to a corporation's IT infrastructure equipment. Previously, with each project obtaining and running its own hardware, ownership of the hardware was assumed by the project. In contrast, using the PIM system 10, a project is simply one of many projects running on a given piece of hardware. Ownership of the hardware is held at a corporate level rather than a project level. This enhances opportunities for equipment reuse and for technology standardization.

Optionally, even though the hardware is held at the corporate level, a respective serial number of each piece of hardware used for a project can be associated with an identifier of the project in an asset center database 84. Thus, for each project, the asset center database 84 can identify each piece of hardware (by its respective serial number) used in the project, a respective amount of resources of the piece of hardware used by the project, and a cost based on the respective amount of resources of the piece of hardware. Although assignment is performed at a serial number level, infrastructure management is to be performed at a resource level as described herein. The asset center database 84 can feed a general ledger system 86 for the organization.

In an embodiment, the PIM system 10 cooperates with a virtual project management office (VPMO) component 90. The VPMO component 90 is a computer-implemented tool that coordinates the individual IT projects. The VPMO component 90 identifies each IT project by a unique identifier. Associated with each unique identifier are the charge code for an IT project, an identifier of the IT project type, a client of the IT project, costs attributed to the IT project and a status of the IT project.

The VPMO component 90 also considers each bulk purchase as an individual project. For example, the VPMO component 90 has an entry that considers the purchase of the additional data center components 34 as an individual project. However, each bulk purchase project is identified as being a different project type than an ordinary project. For example, each bulk purchase project can be identified as being a VPMO sub-type for bulk orders. The VPMO component 90 considers the infrastructure planners 40 to be the client of the bulk purchase project.

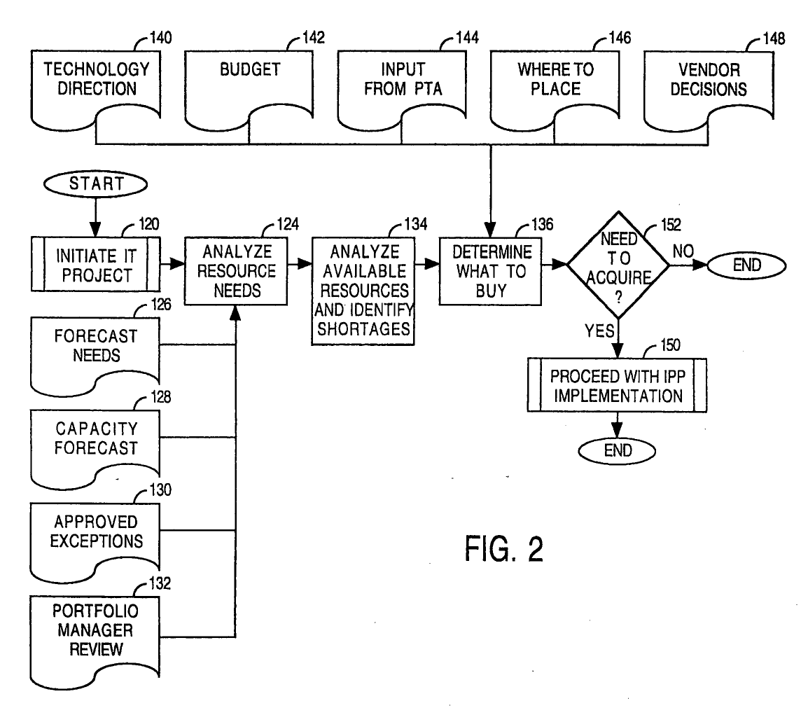

FIGS. 2-7 are flow charts of embodiments of methods that can be performed using the PIM system 10.

FIG. 2 is a flow chart of an embodiment of a method of infrastructure acquisition planning for the multiple projects 24.

As indicated by block 120, the method comprises initiating an IT project for a potential purchase of additional data center components. The IT project can be initiated in response to a user-entered input to open a VPMO number using the VPMO component 90. The project is identified as being a VPMO sub-type for bulk orders with the planner being the client.

As indicated by block 124, the method comprises analyzing resource needs of the data centers 14. The resource needs are analyzed based on forecast needs 126 for the anticipated projects 30, a capacity forecast 128 of the current inventory of IT infrastructure, a log 130 of approved exceptions, and an output 132 of a review with a portfolio manager. The forecast needs 126, the capacity forecast 128, the log 130 and the output 132 may be consolidated in a spreadsheet or another computer document, and outputted for analysis by the infrastructure planners 40.

The forecast needs 126 are needs for new projects (e.g. enhancing projects) as described with reference to FIG. 1. The forecast needs 126 are determined for a future time based on information retrieved from the database 52 of the PIW component 50.

The capacity forecast 128 is a forecast of additional resource needs caused by the currently-deployed projects 26 (e.g. sustaining projects). The additional resource needs may result when a data center component is forecast to be replaced or upgraded, end/or when resources needed from a data center component are forecast to exceed the capacity of a data center component at or before the future time.

The log 130 indicates approved exceptions to a standards list that specifies which particular data center components can be normally selected and purchased. Exceptions are particular data center components that are not normally included in a bulk purchase. The approved exceptions are those exceptions that have been approved. Not all exceptions are necessarily approved.

The output 132 is of a review of project information by a portfolio manager. The organization may have multiple portfolio managers, each having his/her own area to manage. Each portfolio manager may review all of the anticipated projects that are within his/her area of management.

As indicated by block 134, the method comprises analyzing available resources and identifying shortages. The available resources can be analyzed by accessing the database 58. The available resources are for the inventory of the existing data center components 16, any data center components that have been installed but not deployed, any data center components in the process of being installed, and any data center components that are pending install. The shortages are identified based differences between the available resources and the resource needs.

As indicated by block 136, the method comprises determining if any additional data center components are to be purchased to meet any shortages. The determination is made based on a technology direction 140 of the organization, a budget 142 of the organization, input 144 from a principal technical architect (PTA), an indication 146 of where to place the additional data center components (e.g. which data center location(s) are to have the additional data center components), and vendor negotiation and sourcing decision(s) 148.

The budget 142 may be associated with a drill-down process to separate expenditures into buckets such as hardware, software and non-labor expense. An iterative process may be used to ensure that budgeting results are repeatable.

The input 144 from the PTA may be relative to an application or tool to be used across the organization or an impact on infrastructure choice. In general, the input 144 from the PTA may be an early indication of potential programs, projects, or infrastructure needs for the organization of which the application groups are unaware.

If a purchase is to be made, the act of block 136 includes selecting the additional data center components to be purchased. The additional data center components may comprise any combination of data storage components, server components and network components.

As indicated by block 150, the method comprises proceeding with an IPP implementation if any additional data center components are to be acquired (block 152).

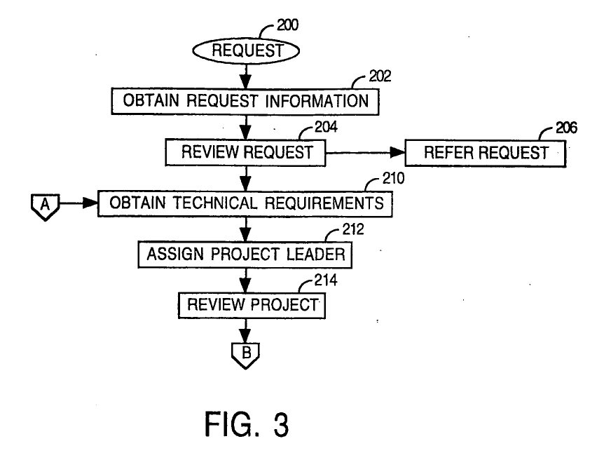

FIG. 3 is a flow chart of an embodiment of a method of project consultation and assessment in an infrastructure provisioning process.

As indicated by block 200, the method comprises receiving a project request from a client. The project request is a request for a new project to be implemented in one or more data centers of the organization. The project request may be initiated in response to a user-entered input to open a VPMO number using the VPMO component 90. The project request includes a description of the new project and other information associated with the project request made by the client.

As indicated by block 202, the method comprises obtaining the information associated with the project request. The information is obtained by the infrastructure planners 40.

As indicated by block 204, the method comprises reviewing the project request and its request information. The project request and the request information are reviewed by the infrastructure planners 40. A decision is made based on the review.

As indicated by block 206, the decision may be to refer the project request to another member of the organization for his/her review before proceeding in the process.

As indicated by block 210, the decision may be to proceed with obtaining technical requirements associated with the new project. The technical requirements are made by the infrastructure planners 40 based on the project request and its request information. Examples of the technical requirements include, but are not limited to, estimates of amounts of various resources required by the new project.

As indicated by block 212, the method comprises assigning a project leader to the new project. The project leader is assigned using the VPMO component 90. The project leader may be selected from one of the IT managers in the organization.

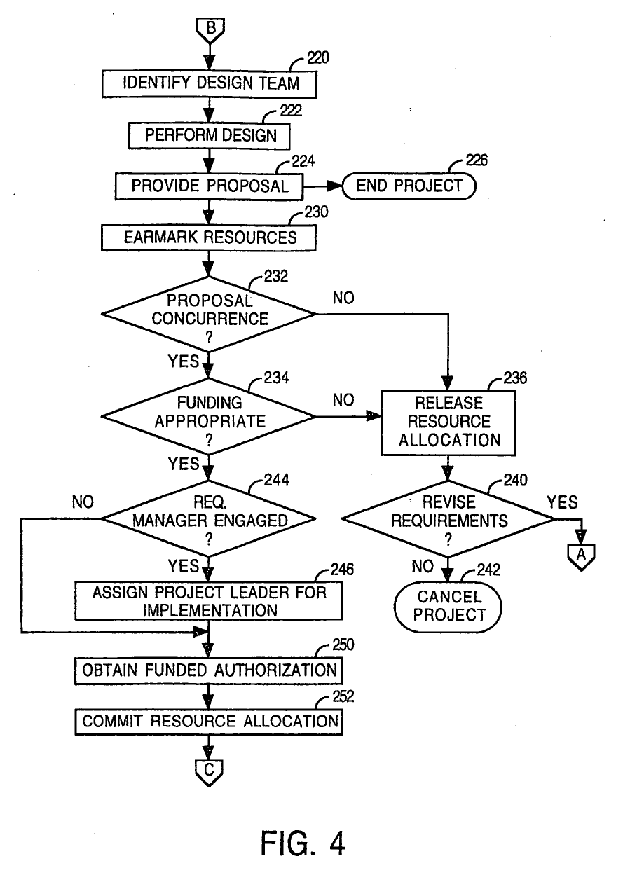

As indicated by block 214, the method comprises reviewing the new project. The new project is reviewed by a project manager, and optionally one or more of the infrastructure planners 40. After the review, the method of FIG. 4 may be performed.

FIG. 4 is a flow chart of an embodiment of a method of project definition and funding in an infrastructure provisioning process.

As indicated by block 220, the method comprises identifying a design team to work on the new project. Based on the request information and the technical requirements, one or more experts in a particular area (e.g. a database expert or a networking expert) may be selected for inclusion in the design team.

As indicated by block 222, the method comprises performing a design of the new project by the design team. The design team performs the design based on the project request, the request information and the technical requirements of the new project. The design specifies how the new project can be realized, and includes a cost estimate for the new project.

As indicated by block 224, the method comprises providing a proposal for the new project based on the design. The proposal includes the specifications and the cost estimate. The client reviews the proposal to determine how to proceed with the new project. As indicated by block 226, the client may wish to terminate any further steps with the new project, in which case the new project is considered terminated and will not be implemented.

As indicated by block 230, the method comprises reserving resources for the new project. The resources are reserved based on the proposal. The infrastructure planners 40 can cause the resources to be reserved by earmarking or otherwise labeling the resources.

As indicated by block 232, the method comprises determining if there is concurrence with the proposal. If there is concurrence with the proposal, the method comprises determining if there is appropriate funding for the proposal as indicated by block 234.

If there is not concurrence with the proposal or if there is not appropriate funding for the proposal, the resources earmarked to the new project are released as indicated by block 236. A decision is made whether or not to revise the requirements of the new project as indicated by block 240. If the decision is to revise the requirements, flow of the method is directed to block 210 in FIG. 3 wherein revised technical requirements are obtained for the new project so that a new design can be performed. Otherwise, the new project is canceled as indicated by block 242.

If there is concurrence with and appropriate funding for the proposal, the method comprises determining if a requirements manager is still engaged as indicated by block 244. The requirements manager is responsible for front-end documentation processing in the consultation and assessment process. Responsibility shifts from the requirements manager to a deployment project leader for an approved and funded project. Thus, if the requirements manager is still engaged at this point in the process, the method comprises assigning a project leader for an implementation of the new project as indicated by block 246.

As indicated by block 250, the method comprises obtaining a funded authorization. In response to obtaining the funded authorization, the method comprises committing to a resource allocation for the new project, as indicated by block 252. This act may comprise the infrastructure planners 40 committing to some or all of the resources earmarked for the new project.

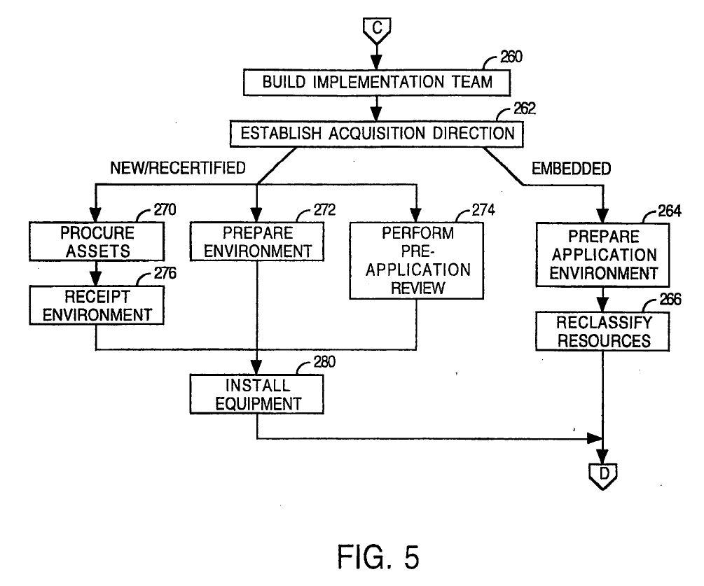

FIG. 5 is a flow chart of an embodiment of a method of project development and testing in an infrastructure provisioning process. The method of FIG. 5 may be performed after the method of FIG. 4.

As indicated by block 260, the method comprises building an implementation team for the new project. The implementation team creates one or more software applications to implement the new project based on the design from the design team.

As indicated by block 262, the method comprises establishing an acquisition direction for the new project. The acquisition direction is a final decision on whether the new project is to be implemented using embedded data center components or new/recertified data center components. The acquisition direction can be determined by the infrastructure planners 40 end/or the client. The client may be offered a reduced price to use embedded data center components in contrast to new/recertified data center components. For example, the client may be offered, free of charge, unused existing resources from a data center component that has been embedded in a data center for at least twelve months.

If the acquisition direction is for one or more embedded data center components, the method comprises preparing an application environment, as indicated by block 264. This act may comprise preparing the data center end/or its embedded data center component to meet the needs of the new project. As indicated by block 266, the method comprises reclassifying resources of the embedded data center component to the new project. In this act, the new project is charged for an amount of resources that the new project is to use. However, the new project may be charged at a reduced price per unit resource because of its use of embedded resources. Under some circumstances, e.g. if the embedded data center component has been on a data center floor for at least twelve months, the price per unit resource may be zero or about zero.

If the acquisition direction is for one or more new/recertified data center components, the method comprises procuring the new data center components as indicated by block 270. The new/recertified data center components are procured from one or more of the external suppliers 62 using at least one consolidated charge code 72. A portion of the charge is reclassified to an individual project code of the new project based on its amount of allocated resources.

As indicated by block 272, the method comprises preparing an environment of the data center to be ready to install the new/recertified data center components. The environment of the data center can be prepared before the new/recertified data center components have been received from the one or more external suppliers. Preparing the environment may include preparing the data center to have suitable powering, cooling and space for the new/recertified data center components.

As indicted by block 274, the method comprises performing a pre-application review. The pre-application review is to verify that the resource requirements for the new project have not changed after the decision was made to procure a new/recertified data center component.

As indicated by block 276, the procured data center components are received from the one or more external suppliers. This act may include logging receipt of the new/recertified data center components in the database 58. The new/recertified data center components can be logged in the database 58 with a status value such as “pending install”.

As indicated by block 280, the method comprises installing the procured data center components in one or more data centers. When a procured data center component is being installed, its status value in the database 58 is changed to “install”. After the procured data center component has been installed, its status value in the database 58 is changed to “PIM complete” or “PIM ready”.

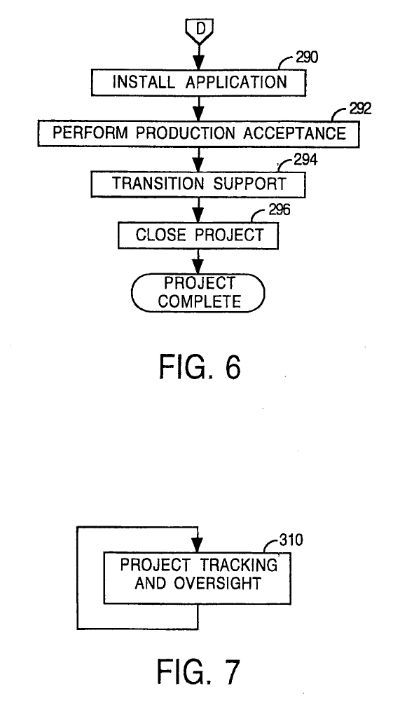

FIG. 6 is a flow chart of an embodiment of a method of project deployment in the infrastructure provisioning process. The method of FIG. 6 may be performed after the method of FIG. 5.

As indicated by block 290, the method comprises installing the application(s) for the new project (that was created by the implementation team) to its allocated data center component(s). As indicated by block 292, a production acceptance test of the application(s) is performed to ensure that the application(s) are properly functioning. As indicated by block 294, support for the application(s) is transitioned from a system introduction team to a production support team. The status of the new project may be changed to “production”. As indicated by block 296, the method comprises closing the new project in the VPMO component 90.

FIG. 7 is a flow chart of an embodiment of recurring activities in the infrastructure provisioning process. As indicated by block 310, tracking and oversight acts are performed for the projects on a recurring basis. Examples of the tracking and oversight acts include, but are not limited to, verifying that charges have been properly reclassified to the projects, comparing cost estimates to actual expenditures, determining an accuracy of cost-per-unit resource values, and making adjustments to improve the accuracy of the cost-per-unit resource values.

Ideally, a group responsible for infrastructure acquisition on an organization-wide basis does not have a year-end profit or loss for acquiring infrastructure for its intra-organization clients. The recurring activities are performed, in part, to ensure that the intra-organization clients are being accurately charged for resources to minimize or otherwise reduce a magnitude of year-end profit or loss.

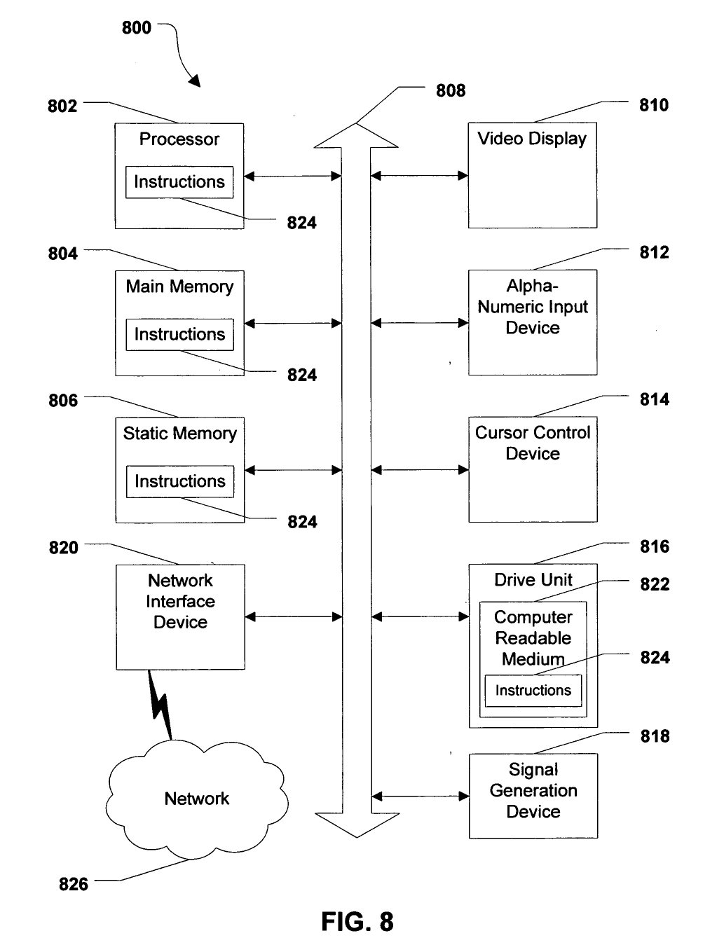

Referring to FIG. 8, an illustrative embodiment of a general computer system is shown and is designated 800. The computer system 800 can include a set of instructions that can be executed to cause the computer system 800 to perform any one or more of the methods or computer based functions disclosed herein. The computer system 800 may operate as a standalone device or may be connected, e.g., using a network, to other computer systems or peripheral devices. Further, the computer system 800 can execute one or more of the method steps described herein. Also, the computer system 800 can include one or more of the elements described in conjunction with FIG. 1.

In a networked deployment, the computer system may operate in the capacity of a server or as a client user computer in a server-client user network environment, or as a peer computer system in a peer-to-peer (or distributed) network environment. The computer system 800 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 800 can be implemented using electronic devices that provide voice, video or data communication. Further, while a single computer system 800 is illustrated, the term “system” shall also be taken to include any collection of systems or sub-systems that individually or jointly execute a set, or multiple sets, of instructions to perform one or more computer functions.

As illustrated in FIG. 8, the computer system 800 may include a processor 802, e.g., a central processing unit (CPU), a graphics processing unit (GPU), or both. Moreover, the computer system 800 can include a main memory 804 and a static memory 806, that can communicate with each other via a bus 808. As shown, the computer system 800 may further include a video display unit 810, such as a liquid crystal display (LCD), an organic light emitting diode (OLED), a flat panel display, a solid state display, or a cathode ray tube (CRT). Additionally, the computer system 800 may include an input device 812, such as a keyboard, and a cursor control device 814, such as a mouse. The computer system 800 can also include a disk drive unit 816, a signal generation device 818, such as a speaker or remote control, and a network interface device 820.

In a particular embodiment, as depicted in FIG. 8, the disk drive unit 816 may include a computer-readable medium 822 in which one or more sets of instructions 824, e.g. software, can be embedded. Further, the instructions 824 may embody one or more of the methods or logic as described herein. In a particular embodiment, the instructions 824 may reside completely, or at least partially, within the main memory 804, the static memory 806, end/or within the processor 802 during execution by the computer system 800. The main memory 804 and the processor 802 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 824 or receives and executes instructions 824 responsive to a propagated signal, so that a device connected to a network 826 can communicate voice, video or data over the network 826. Further, the instructions 824 may be transmitted or received over the network 826 via the network interface device 820.

While the computer-readable medium is shown to be a single medium, the term “computer-readable medium” includes a single medium or multiple media, such as a centralized or distributed database, end/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually end/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method comprising:
receiving anticipated-resource-usage values for a plurality of anticipated projects;
determining a forecast need of at least one data center for a future time based on the anticipated-resource-usage values;
determining if an existing inventory of data center components satisfies the forecast need;
procuring at least one data center component from at least one external supplier to satisfy the forecast need when the existing inventory does not satisfy the forecast need;
allocating a respective amount of resources of the at least one data center component to approved ones of the anticipated projects; and
charging each of the approved ones of the anticipated projects for said procuring based on the respective amount of resources allocated thereto.

2. The method of claim 1 wherein said determining the forecast need is further based on a non-project-specific need.

3. The method of claim 2 wherein the non-project-specific need comprises a disaster recovery need.

4. The method of claim 2 wherein the non-project-specific need comprises a data center security need.

5. The method of claim 2 wherein the non-project-specific need comprises a networking need.

6. The method of claim 2 further comprising:
charging a first approved one of the anticipated projects for a cost associated with satisfying the non-project-specific need.

7. The method of claim 1 wherein the future time is between about 60 to 120 days, inclusive, from a time of performing said determining the forecast need.

8. The method of claim 1 further comprising:
selecting the at least one data center component to include a partitionable data center component that can deploy multiple ones of the anticipated projects.

9. The method of claim 1 wherein the anticipated projects comprise a first project and a second project, the method further comprising:
selecting a first data center component whose capacity satisfies a first anticipated-resource-usage of the first project and a second anticipated-resource-usage of the second project;
wherein the at least one data center component being procured includes the first data center component.

10. The method of claim 9 further comprising:
deploying the first project and the second project on the first data center component.

11. The method of claim 1 further comprising:
selecting the at least one data center component to be procured to satisfy the forecast need based on if a technology shift is desired for the at least one data center.

12. The method of claim 11 wherein when the technology shift is not desired, said selecting ensures that none of the at least one data center component has the technology shift.

13. The method of claim 11 wherein when the technology shift is desired, said selecting comprises selecting a data center component that has the technology shift.

14. The method of claim 1 wherein the at least one data center component comprises at least one data storage component, and wherein the respective amount of resources comprises a respective amount of storage space.

15. The method of claim 1 wherein the at least one data center component comprises at least one server, and wherein the respective amount of resources comprises a respective transaction rate.

16. The method of claim 1 wherein the at least one data center component comprises at least one switch, and wherein the respective amount of resources comprises a respective number of ports.

17. The method of claim 1 further comprising:
using at least consolidated charge code to pay for the at least one data center component in said procuring;
wherein said charging each of the approved ones of the anticipated projects comprises reclassifying charges from the at least one consolidated charge code to a plurality of individual project charge codes.

18. The method of claim 1 further comprising:
authorizing funding for a first project of the anticipated projects;
wherein said procuring the at least one data center component is performed before said authorizing funding for the first project; and
wherein said charging comprises charging the first project based on its respective amount of resources of the at least one data center component after said authorizing funding for the first project.

19. The method of claim 18 further comprising:
using at least consolidated charge code to pay for the at least one data center component in said procuring;
wherein said charging the first project comprises reclassifying a portion of a charge from the at least one consolidated charge code to an individual project code associated with the first project.

20. The method of claim 1 further comprising:
installing the at least one data center component in the at least one data center up to a point that requires individual application customization; and
making the at least one data center component eligible for a deployment process after said installing.
